(19) United States
(12) Patent Application Publication
(10) Pub. No.: US 2010/0166248 A1
(43) Pub. Date: Jul. 1, 2010

(54) Speaker with heat dissipation arrangement

(75) Inventor: Steff Lin, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: HI-TECH SOUND SYSTEM CO., LTD., Taipei (TW)

(21) Appl. No.: 12/318,479

(22) Filed: Dec. 30, 2008

(51) Int. Cl. H04R 11/02

(52) U.S. Cl. 381/400

(57) ABSTRACT

A speaker having a heat-transfer upper bearing cup fastened to the bottom side of the cone paper, a bottom bearing cup set between the heat-transfer upper bearing cup and the damper, and a heat-transfer sound coil holder capped on the sound coil with bottom hooks thereof fastened to the heat-transfer upper bearing cup and the damper to establish with the heat-transfer upper bearing cup a heat dissipation structure for quick dissipation of heat from the sound coil during the operation of the speaker, thereby raising the output power.

### BACKGROUND OF THE INVENTION

1. Field of the Invention

The present invention relates to speakers and more particularly, to a heat dissipation arrangement used in a speaker to avoid dropping of the sound coil, thereby raising the output power.

2. Description of the Related Art

FIG. 1 shows a conventional speaker 1, which comprises a bracket 14, a T-iron 11, an annular magnet 12 supported on the T-iron 11, a washer 13 covered on the magnet 12 opposite to the T-iron 11 and fastened with the magnet 12 and the T-iron 11 to the bottom side of the bracket 14, a sound coil 16 wound round the axle bush at the center of the T-iron 11 and suspending in the magnet 12, a cone paper 15 suspending inside the bracket 14 around the sound coil 16. When an electric current is connected to the sound coil 16 to magnetize the magnet 12, the cone paper 15 is caused to vibrate, thereby producing sound. However, because the sound coil 16 is bonded to the cone paper 15 with a bonding glue, generated heat during operation of the sound coil 16 may melt the bonding glue, causing the sound coil 16 to drop from the cone paper 15. Further, the poor sound coil dissipation effect causes the output power of the speaker unable to be raised.

Therefore, it is desirable to provide a speaker that eliminates the aforesaid problem.

### SUMMARY OF THE INVENTION

The present invention has been accomplished under the circumstances in view. It is one object of the present invention to provide a speaker, which has heat dissipation means to dissipate heat from the sound coil rapidly. It is another object of the present invention to provide a speaker, which is easy to install and effectively avoids dropping of the sound coil, and raises the output power

To achieve these and other objects of the present invention, the speaker, a bracket, a stack of magnets and washers mounted in the bracket, a cone paper and a damper suspending in the bracket, and a sound coil sleeved onto the stack of magnets and washers, wherein the speaker further comprises a heat-transfer upper bearing cup mounted in the damper inside the bracket beneath the cone paper, the upper bearing cup having the rim thereof bonded to the cone paper, a heat-transfer sound coil holder fastened to the inside of the heat-transfer upper bearing cup and surrounding the sound coil to hold the sound coil in place and adapted for transferring heat from the sound coil to the heat-transfer upper bearing cup for dissipation, thereby raising the output power.

Further, the heat-transfer upper bearing cup comprises a plurality of equiangularly spaced mounting through holes. Further, the damper comprises a plurality of equiangularly spaced mounting through holes corresponding to the mounting through holes of the heat-transfer upper bearing cup. Further, the heat-transfer sound coil holder comprises a plurality of bottom hooks respectively hooked in the mounting through holes of the heat-transfer upper bearing cup and the damper.

### BRIEF DESCRIPTION OF THE DRAWINGS

FIG. 1 is a sectional view of a conventional speaker.

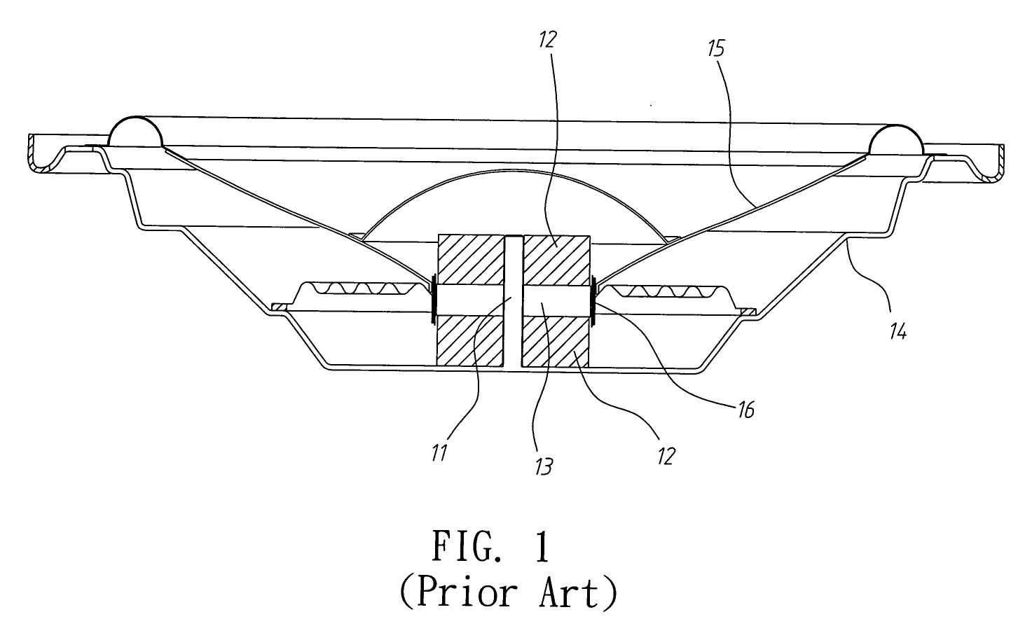

FIG. 2 is a perspective view of a speaker in accordance with the present invention.

FIG. 3 is an exploded view of the speaker in accordance with the present invention.

FIG. 4 is a sectional view of the speaker in accordance with the present invention.

### DETAILED DESCRIPTION OF THE PREFERRED EMBODIMENT

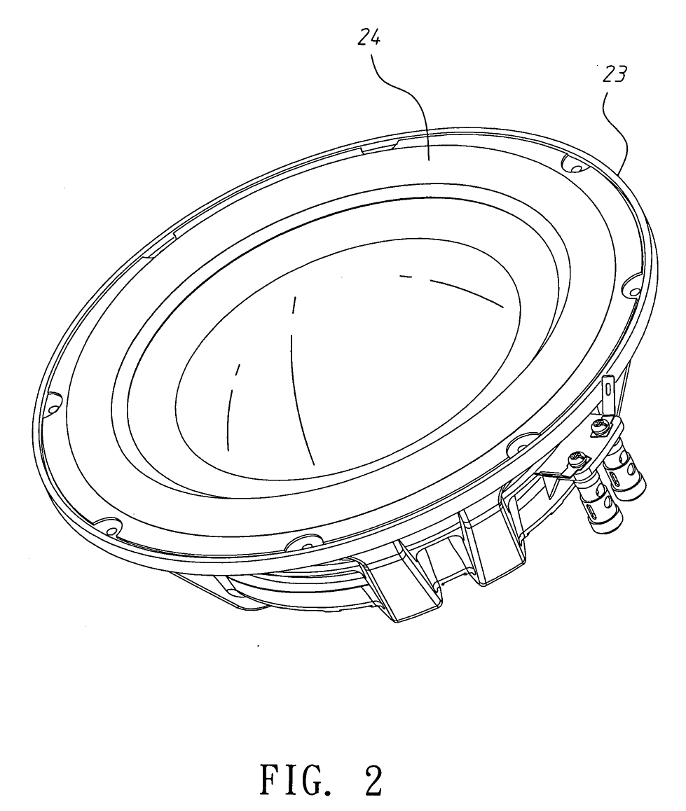

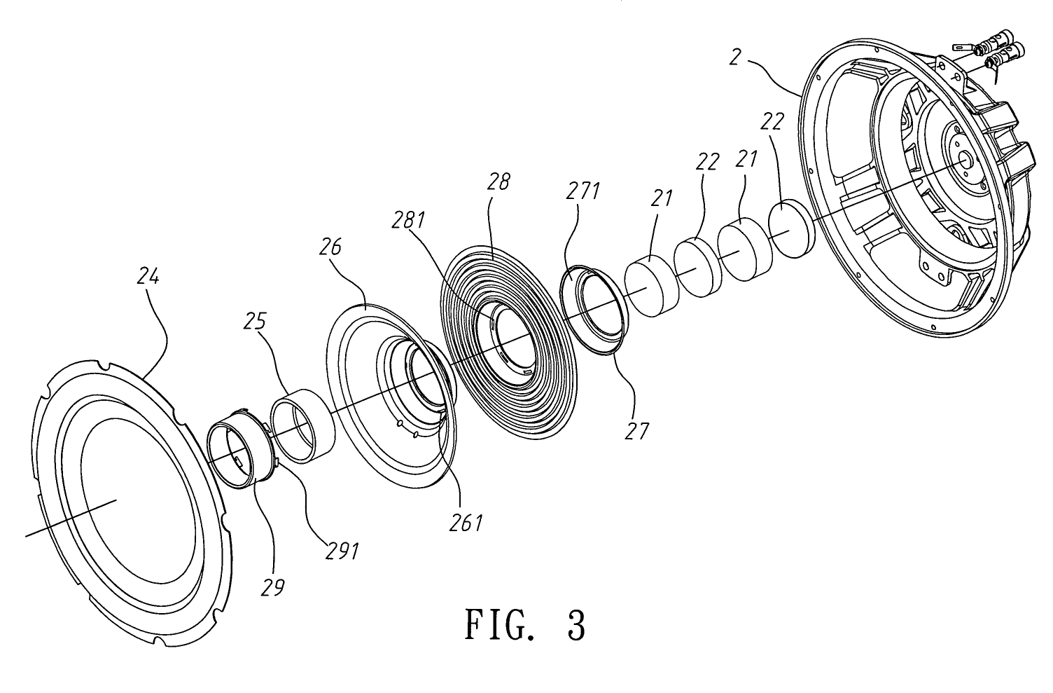

Referring to FIGS. 2 and 3, a speaker constructed according to the present invention is shown comprising a bracket 23, two magnets 21, two washers 22 alternatively arranged with the magnets 21 in a stack inside the bracket 20, an upper bearing cup 26 prepared from a material having high thermal conductivity and suspending in the bracket 2 and having a plurality of equiangularly spaced mounting through holes 261, a cone paper 24 fastened to the rim of the upper bearing cup 26 and the rim of the bracket 23, a damper 28, which has the periphery thereof fastened to the bracket 23 and a plurality of equiangularly spaced mounting through holes 281, a bottom bearing cup 27, which is set in between the upper bearing cup 26 and the damper 28 and has a plurality of mounting through holes 271, a cylindrical sound coil holder 29 prepared from a material having high thermal conductivity, which is fastened to the top bearing cup 26 and has a plurality of equiangularly spaced and substantially L-shaped bottom hooks 291, the bottom bearing cup 27 and the damper 28, a sound coil 25 mounted in the sound coil holder 29. The sound coil 25 surrounds the magnets 21. The sound coil holder 29 is capped on the sound coil 25 to hook the bottom hooks 291 in the mounting through holes 261 of the upper bearing cup 26, the mounting through holes 271 of the bottom bearing cup 27 and the mounting through holes 281 of the damper 8. When connecting an electric current to the sound coil 25 to excite the sound coil 25, the cone paper 24 is caused to vibrate. During operation of the sound coil 25, heat energy generated by the sound coil 25 is transferred through the sound coil holder 29 and the upper bearing cup 26 to the outside open air, i.e., the sound coil holder 29 and the upper bearing cup 26 constitute a heat dissipation structure for quick dissipation of heat from the sound coil 25, avoiding melting of the bonding glue that is applied to the sound coil 25 for fixation. Therefore, the sound coil 25 is positively secured in place, assuring high performance and raising the output power.

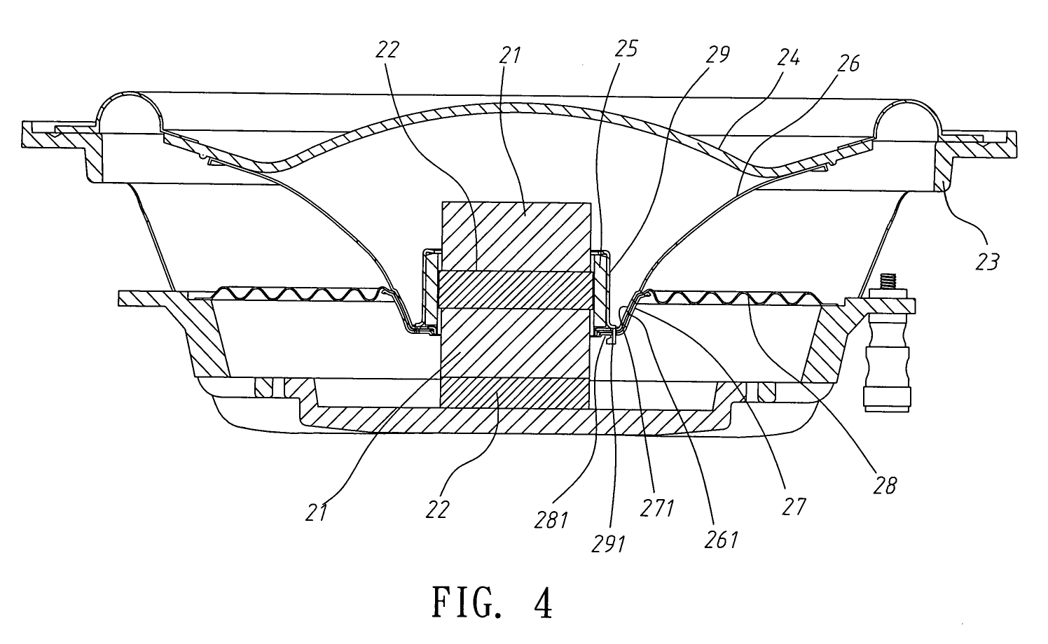

Referring to FIG. 4, when the speaker is assembled, the sound coil 25 is surrounded by the sound coil holder 29, and the bottom hooks 291 of the sound coil holder 29 are respectively hooked in the mounting through holes 261 of the upper bearing cup 26, the mounting through holes 271 of the bottom bearing cup 27 and the mounting through holes 281 of the damper 8, securing the upper bearing cup 26, the bottom bearing cup 27 and the damper 8 together. At this time, the sound coil holder 29 and the upper bearing cup 26 constitute a heat dissipation structure for quick dissipation of heat from the sound coil 25, avoiding melting of the bonding glue that is applied to the sound coil 25 for fixation, thereby raising the output power

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A speaker, comprising a bracket, a stack of magnets and washers mounted in said bracket, a cone paper and a damper suspending in said bracket, and a sound coil sleeved onto said stack of magnets and washers, wherein the speaker further comprises a heat-transfer upper bearing cup mounted in said damper inside said bracket beneath said cone paper, said upper bearing cup having the rim thereof bonded to said cone paper, a heat-transfer sound coil holder fastened to the inside of said heat-transfer upper bearing cup and surrounding said sound coil to hold said sound coil in place and adapted for transferring heat from said sound coil to said heat-transfer upper bearing cup for dissipation, thereby raising the output power

2. The speaker as claimed in claim 1, wherein said heat-transfer upper bearing cup comprises a plurality of equiangularly spaced mounting through holes; said damper comprises a plurality of equiangularly spaced mounting through holes corresponding to the mounting through holes of said heat-transfer upper bearing cup; said heat-transfer sound coil holder comprises a plurality of bottom hooks respectively hooked in the mounting through holes of said heat-transfer upper bearing cup and said damper.

3. The speaker as claimed in claim 1, further comprising a bottom bearing cup mounted in said damper, said bottom bearing cup comprising a plurality of mounting through holes respectively fastened to said bottom hooks of said heat-transfer sound coil holder.

4. The speaker as claimed in claim 2, wherein said bottom hooks of said heat-transfer sound coil holder are L-shaped hooks.
